(19) United States
(12) Patent Application Publication
(10) Pub. No.: US 2020/0128618 A1
(43) Pub. Date: Apr. 23, 2020

(54) SYSTEM INFORMATION DECODING IN WIRELESS NETWORKS

(71) Applicant: Intel IP Corporation, Santa Clara, CA (US)

(72) Inventors: Shuang TIAN, Santa Clara, CA (US); Yang TANG, San Jose, CA (US); Jie CUI, Santa Clara, CA (US); Anatoliy IOFFE, Beaverton, OR (US); Andrey CHERVYAKOV, Nizhny Novgorod, NIZ (RU)

(21) Appl. No.: 16/477,497

(22) PCT Filed: Feb. 15, 2018
(86) PCT No.: PCT/US2018/018317

§ 371 Date: Jul. 11, 2019

Related U.S. Application Data
(60) Provisional application No. 62/459,369, filed on Feb. 15, 2017.

(51) Int. Cl. H04W 88/02; H04L 5/00; H04W 28/06; H04B 17/336

(52) U.S. Cl. CPC H04W 88/025; H04B 17/336; H04W 28/06; H04L 5/0082

(57) ABSTRACT

Embodiments include apparatuses, methods, and systems that may decode system information by a UE in a wireless network to communicate with an eNB or a gNB. The apparatus may include a memory and processing circuitry coupled with the memory. The processing circuitry may identify a remaining time period of a current moment in a current time window, identify a decoding time interval for decoding system information based on a channel condition for a channel between the UE and the eNB or the gNB. Based on a first relationship between the decoding time interval and the remaining time period, the processing circuitry may store, or cause to store, in the memory one or more copies of the system information received during the decoding time interval; and may further decode, or cause to decode, the one or more copies of the system information. Other embodiments may also be described and claimed.

### CROSS REFERENCE TO RELATED APPLICATIONS

The present application claims priority from U.S. Provisional Patent Application No. 62/459,369, filed Feb. 15, 2017, and entitled “POWER SAVING FOR SYSTEM INFORMATION ACQUISITION,” the entire disclosure of which is hereby incorporated by reference.

### TECHNICAL FIELD

Embodiments generally may relate to the field of wireless communications.

### BACKGROUND

Long Term Evolution (LTE) networks may provide wireless communication to various user equipments (UEs). Multiple other wireless systems may provide similar wireless communications as well.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a schematic high-level example of a wireless network that includes multiple user equipments (UEs), and an evolved Node B (eNB) or a next generation Node B (gNB), where one or more copies of system information may be received during a time window, in accordance with various embodiments.

FIG. 2 illustrates an example time window including a number of transmission time intervals (TTIs), and a number of copies of system information to be received within a TTI, in accordance with various embodiments.

FIG. 3 illustrates example relationships between a remaining time period of a current moment in a time window and a decoding time interval for system information, in accordance with various embodiments.

FIG. 4 illustrates another example time window including a number of TTIs, and a number of copies of system information to be received within a TTI, in accordance with various embodiments.

FIG. 5 illustrates another example time window including a number of TTIs, and a number of copies of system information to be received within a TTI, in accordance with various embodiments.

FIG. 6 illustrates an example operation flow for a UE to determine to decode or discard one or more copies of system information within a decoding time interval, in accordance with various embodiments.

FIG. 7 illustrates a block diagram of an implementation for eNBs, gNodeB, and/or UEs, in accordance with various embodiments.

FIG. 8 illustrates interfaces of baseband circuitry as a part of an implementation for eNBs, gNBs, and/or UEs, in accordance with various embodiments.

FIG. 9 illustrates a block diagram illustrating components able to read instructions from a machine-readable or computer-readable medium and perform any one or more of the methodologies discussed herein, in accordance with various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

To meet the ever-increasing traffic demand, the 3rd Generation Partnership Project (3GPP) has been continuously increasing a wireless network capacity, capability, throughput, efficiency, and/or applications of wireless networks, such as Long Term Evolution (LTE) networks, through various techniques. A wireless network may be referred to as a mobile communication network. For example, 3GPP has defined a new air interface called as 5G New Radio (NR) technology. 5G NR technology may include new features and technologies to provide a customized connection to any device, such as a sensor, a vehicle, a smartphone, or other devices. In addition, NarrowBand Internet of Things (NB-IoT) may be a low power wide area network (LPWAN) radio technology standard developed to enable a wide range of devices and services to be connected using cellular communications bands. Other alternatives may include machine type communications (MTC), enhanced machine-type communication (eMTC), mobile IoT (MIoT) technologies, extended coverage global system for mobile communications (GSM) IoT (EC-GSM-IoT), or other wireless networks.

In a communication system, e.g., a 3GPP LTE system, the system information (SI) may convey important system control information, such as system configuration, resources allocation, and scheduling, from an evolved Node B (eNB) or a next generation Node B (gNB) to a user equipment (UE). In general, a SI may be kept unchanged over a certain period of time, e.g., a time window. During a time window, a SI may be repeatedly broadcasted by an eNB or a gNB to one or more UEs, and a UE may attempt to decode a received SI to acquire the system information. On the other hand, system information of different time windows may be different.

In some wireless systems, e.g., a NB-IoT system or a MTC system, the signal-to-noise power ratio (SNR) of a channel between a UE and an eNB or a gNB may be lower compared with other legacy LTE systems. In a NB-IoT system or a MTC system, a UE may not be able to successfully decode a system information within a single try. Instead, a UE may accumulate multiple copies of a same system information, and decode the multiple copies of the same system information to increase the chance for success. Sometimes, the time period for a UE to accumulate enough copies of the system information may be larger than a duration of a time window when the system information may be the same. Therefore, simply accumulating enough copies of the system information before decoding the multiple copies may not be able to determine a correct system information for a current time window. Accordingly, a UE may waste power resource to decode system information that may not be useful.

In embodiments, an apparatus may be used in a UE in a wireless network to communicate with an eNB or a gNB. The apparatus may include a memory, and processing circuitry coupled with the memory. The processing circuitry may identify a remaining time period of a current moment in a current time window. In addition, the processing circuitry may identify a decoding time interval for decoding system information based on a channel condition for a channel between the UE and the eNB or the gNB. Based on a first relationship between the decoding time interval and the remaining time period, the processing circuitry may store, or cause to store, in the memory one or more copies of the system information received during the decoding time interval. Afterwards, the processing circuitry may decode, or cause to decode, the one or more copies of the system information.

In embodiments, a computer-readable medium may include instructions to cause a UE in a mobile communication network to communicate with an eNB or a gNB. When the instructions are executed by one or more processors, the UE may identify a remaining time period for a current moment of a current time window. In addition, based on a channel condition for a channel between the UE and the eNB or the gNB, the processing circuitry may identify a decoding time interval for decoding system information. Based on a first relationship between the decoding time interval and the remaining time period, the processing circuitry may store, or cause to store, in a memory one or more copies of the system information received during the decoding time interval. Furthermore, the processing circuitry may decode, or cause to decode, the one or more copies of the system information.

In embodiments, an apparatus may be used in a UE in a mobile communication network to communicate with an eNB or a gNB. The apparatus may include means for identifying a remaining time period for a current moment of a current time window, where the current time window is a time window including a first number of transmission time intervals (TTIs), a second number of copies of a system information are to be received within a TTI, and the system information is unchanged within the time window. The apparatus may further include means for identifying a decoding time interval for decoding the system information based on a channel condition for a channel between the UE and the eNB or the gNB. Based on a first relationship between the decoding time interval and the remaining time period, the apparatus may include means for storing, or causing to store, a third number of copies of the system information received during the decoding time interval. Furthermore, the apparatus may include means for decoding, or causing to decode, the third number of copies of the system information.

For the purposes of the present disclosure, the phrases “A/B,” “A or B,” and “A and/or B” mean (A), (B), or (A and B). For the purposes of the present disclosure, the phrases “A, B, or C” and “A, B, and/or C” mean (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As discussed herein, the term “module” may be used to refer to one or more physical or logical components or elements of a system. In some embodiments, a module may be a distinct circuit, while in other embodiments a module may include a plurality of circuits.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “processor circuitry” may refer to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

As used herein, the term “interface circuitry” may refer to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like).

As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources. Examples of “computer devices”, “computer systems”, etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management Systems (EEMSs), electronic/engine control units (ECUs), vehicle-embedded computer devices (VECDs), autonomous or semi-autonomous driving vehicle (hereinafter, simply ADV) systems, in-vehicle navigation systems, electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

As used herein, the term “network element” may be considered synonymous to and/or referred to as a networked computer, networking hardware, network equipment, router, switch, hub, bridge, radio network controller, radio access network device, gateway, server, and/or any other like device. The term “network element” may describe a physical computing device of a wired or wireless communication network and be configured to host a virtual machine. Furthermore, the term “network element” may describe equipment that provides radio baseband functions for data and/or voice connectivity between a network and one or more users. The term “network element” may be considered synonymous to and/or referred to as a “base station.” As used herein, the term “base station” may be considered synonymous to and/or referred to as a node B, an enhanced or evolved node B (eNB), next generation nodeB (gNB), base transceiver station (BTS), access point (AP), roadside unit (RSU), etc., and may describe equipment that provides the radio baseband functions for data and/or voice connectivity between a network and one or more users. As used herein, the terms “vehicle-to-vehicle” and “V2V” may refer to any communication involving a vehicle as a source or destination of a message. Additionally, the terms “vehicle-to-vehicle” and “V2V” as used herein may also encompass or be equivalent to vehicle-to-infrastructure (V2I) communications, vehicle-to-network (V2N) communications, vehicle-to-pedestrian (V2P) communications, or V2X communications

As used herein, the term “channel” may refer to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for the purpose of transmitting and receiving information.

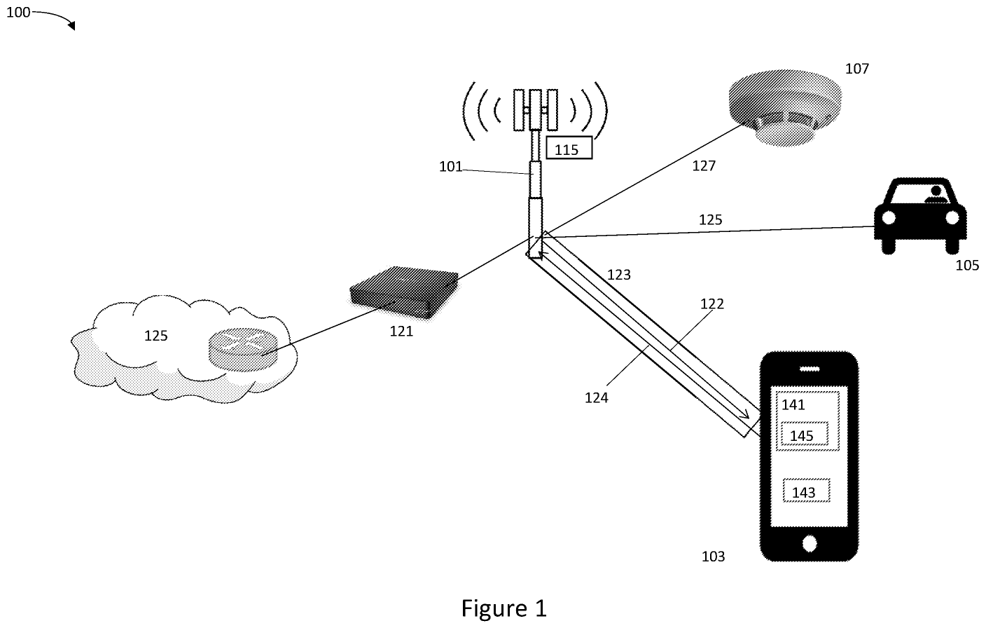

FIG. 1 illustrates a schematic high-level example of a wireless network 100 that includes multiple UEs, e.g., a UE 103 that may be a smartphone, a UE 105 that may be an onboard vehicle system, a UE 107 that may be a sensor, and an eNB or a gNB, e.g., an eNB or a gNB 101, where one or more copies of system information, e.g., system information 115 or system information 145, may be received during a time window, in accordance with various embodiments. For clarity, features of a UE, an eNB, a gNB, or a system information, e.g., the UE 103, the UE 105, the UE 107, the eNB or the gNB 101, the system information 115, the system information 145, may be described below as examples for understanding an example UE, an eNB, a gNB, or system information. It is to be understood that there may be more or fewer components within a UE, an eNB, a gNB, or system information. Further, it is to be understood that one or more of the components within a UE, an eNB, a gNB, or system information, may include additional and/or varying features from the description below, and may include any device that one having ordinary skill in the art would consider and/or refer to as a UE, an eNB, a gNB, or system information. While some embodiments are described with respect to an eNB, the concepts may be equally applicable to a gNB unless otherwise stated.

In embodiments, the wireless system 100 may include multiple UEs, e.g., the UE 103, the UE 105, the UE 107, and the eNB 101 operating over a physical resource of a medium, e.g., a medium 123, a medium 125, a medium 127, or other medium. In embodiments, a UE, e.g., the UE 103, may be an IoT UE, a MTC UE, a machine-to-machine (M2M) UE, a NB-IoT UE, or a MIoT UE. A medium, e.g., the medium 123, may include a downlink 122 and an uplink 124. The eNB 101 may be coupled to a core network 125. In some embodiments, the core network 125 may be coupled to the eNB 101 through a wireless communication router 121.

In embodiments, the eNB 101 may determine or generate a system information 115. The system information 115 may include information for system configuration, resource allocation, scheduling, or other system information. The system information 115 may be carried by a master information block (MIB), a system information block (SIB) 1, a SIB 2, or a SIB 3. The eNB 101 may transmit the system 115 to the UE 103 through the downlink 122. The system information 115 may be carried by multiple frames within a transmission time interval (TTI). For example, a first portion of the system information may be carried by a first subframe of a first frame, and a second portion of the system information may be carried by a second subframe of a second frame.

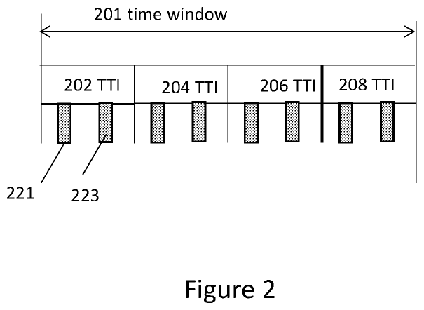

In embodiments, the eNB 101 may repeatedly broadcast multiple copies of a same system information 115 during a time window. For example, as shown in FIG. 2, a time window 201 may include one or more TTIs, e.g., a TTI 202, a TTI 204, a TTI 206, and a TTI 208. The system information 115 may remain unchanged within the time window 201 for the TTI 202, the TTI 204, the TTI 206, and the TTI 208. One or more copies of the system information 115, e.g., a copy 221, and a copy 223, may be repeatedly broadcasted by the eNB 101 during the TTI 202. The number of TTIs included in the time window 201, and the number of copies of the system information 115 included in the TTI 202, are shown for examples only, and may not be limited. There may be other numbers of TTIs included in the time window 201, and other numbers of copies of the system information 115 included in a TTI.

The UE 103 may include a memory 141, and processing circuitry 143 coupled with the memory 141. During a time window, e.g., the time window 201, the UE 103 may receive one or more copies of the system information 115 and may save the received one or more copies of the system information 115 to become one or more copies system information 145 in the memory 141. Alternatively, the UE 103 may discard received system information 115 to reduce computation and save energy.

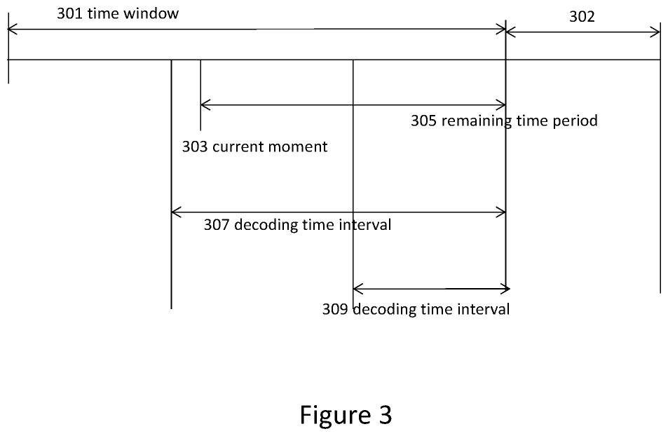

In embodiments, at any given moment, which may be termed as a current moment, the processing circuitry 143 may identify a remaining time period of a current moment in a current time window. For example, as shown in FIG. 3, for a current moment 303 of a time window 301, the processing circuitry 143 may identify a remaining time period 305 within the time window 301. For example, the time window 301 may have a duration of 40.96 second (s). The processing circuitry 143 may decode an MIB, which may include the system frame number indicating the position in the time sequence of the transmission, to determine the current moment 303, and further determine the remaining time period 305.

In addition, the processing circuitry 143 may identify a decoding time interval for decoding system information based on a channel condition for a channel, e.g., the downlink 122 between the UE 103 and the eNB 101. The channel condition may be indicated by a SNR of the channel, e.g., a SNR in a range of about 10 db to 30 db for the downlink 122. For example, as shown in FIG. 3, the processing circuitry 143 may identify a decoding time interval 307 within the time window 301, or a decoding time interval 309 within the time window 301, based on a channel condition for the downlink 122. The decoding time interval may change from one time moment to another, depending on the channel condition for the channel at the time moment. A decoding time interval, e.g., the decoding time interval 307 or the decoding time interval 309, may include multiple TTIs. In one example, the processing circuitry 143 may determine that under a certain SNR value for the downlink 122, the processing circuitry 143 may have a success rate over a threshold value, e.g., 95%, by decoding 64 copies of the system information 145. If a system information 115 is sent repeatedly 16 times within a TTI, 64 copies of the system information 145 may be accumulated over 4 TTIs. When a TTI has a duration of 2560 ms, the processing circuitry 143 may identify the decoding time interval for decoding system information to be 4*2560 ms=10.24 s, which may be represented by the decoding time interval 307. As another example, the processing circuitry 143 may determine that under another SNR value for the downlink 122, the processing circuitry 143 may have a success rate over 95% by decoding 32 copies of the system information 145. Hence, the processing circuitry 143 may identify the decoding time interval for decoding system information to be 2*2560 ms=5.12 s, which may be represented by the decoding time interval 309.

As shown in FIG. 3, different decoding time intervals may have different relationships with the remaining time period with respect to a current moment. For the remaining time period 305, the decoding time interval 307 may be larger than the remaining time period 305, while the decoding time interval 309 may be smaller than the remaining time period 305. Other relationships, e.g., less than or equal to, greater than or equal to, may exist between a decoding time interval and a remaining time period with respect to a current moment.

In embodiments, the processing circuitry 143 may identify that a first relationship between the decoding time interval 309 and the remaining time period 305 is satisfied, the processing circuitry 143 may store, or cause to store, in the memory 141, one or more copies of the system information 145 received during the decoding time interval 309. Afterwards, the processing circuitry 143 may decode, or cause to decode, the one or more copies of the system information 145. In some embodiments, the first relationship between the decoding time interval 309 and the remaining time period 305 is to indicate that the decoding time interval 309 has a duration shorter than or equal to a duration of the remaining time period 305. In some embodiments, the processing circuitry 143 may further decode at least one copy of the system information 145 stored within the current time window 301 before the current moment 303. For example, the decoding time interval 309 may have a value of 5.12 s, smaller than the remaining time period 305 with a value of 10 s. Hence, the processing circuitry 143 may store, or cause to store, in the memory 141, one or more copies of the system information 145 received during the decoding time interval 309, and further decode, or cause to decode, the one or more copies of the system information 145.

In some other embodiments, the processing circuitry 143 may identify that a second relationship between the decoding time interval 307 and the remaining time period 305 is satisfied, the processing circuitry 143 may discard, or cause to discard, the one or more copies of the system information 115 received during the decoding time interval 307, or received during the remaining window 305. For example, the decoding time interval 307 may have a value of 10.24 s, larger than the remaining time period 305 with a value of 10 s. Hence, the processing circuitry 143 may decide to discard, or cause to discard, the one or more copies of the system information 115 received during the decoding time interval 307, or received during the remaining window 305, and restart to store received system information in a next time window 302. Hence, the processing circuitry 143 may reduce the unnecessary storing and decoding of system information 145, during the decoding time interval 307, or the remaining window 305, to save power.

In some embodiments, the medium 123 may be a narrowband channel with a bandwidth of 180 kHz or 200 kHz. In some other embodiments, the medium 123 may be a band in any frequency range (in particular 0 Hz-300 GHz), such as for example unlicensed bands (as the 5 GHz ISM band) or the licensed-by-rule approach which is applied by the FCC (Federal Communications Commission) to the 3.5 GHz Spectrum Access System (SAS) General Authorized Access (GAA) tier, etc. Some targets for future application may include the 28, 37 and 60 GHz bands. In particular, techniques that have been designed for unlicensed bands may be used straightforwardly (only adapting the channel access parameters as described in this document) but also various other systems can be used following a suitable adaptation (see for example the modification of 3GPP LTE to introduce LAA in the 5 GHz ISM band).

In embodiments, the wireless network 100 may include in particular the following: LTE and Long Term Evolution-Advanced (LTE-A) and LTE-Advanced Pro, 5th Generation (5G) communication systems, a NB-IoT network, a LPWAN, a MTC, an eMTC, a MIoT, an EC-GSM-IoT, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE, 3GPP LTE Advanced (Long Term Evolution Advanced)), 3GPP LTE-Advanced Pro, CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 14), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), ETSI OneM2M, IoT (Internet of things), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for “Autoradiopuhelin car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, etc.), etc. It is understood that such exemplary scenarios are demonstrative in nature, and accordingly may be similarly applied to other mobile communication technologies and standards.

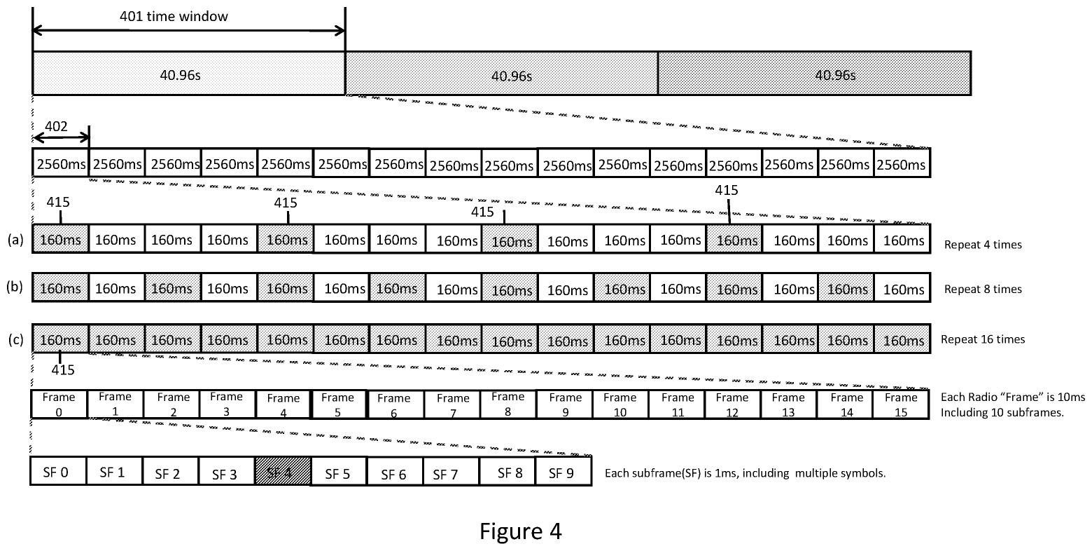

FIG. 4 illustrates another example time window 401 including a number of TTIs, and a number of copies of system information to be received within a TTI, in accordance with various embodiments. In embodiments, the time window 401 may be an example of the time window 201, the time window 301, or the time window 302.

In embodiments, the time window 401 may have a duration of 40.96 seconds, and may include 16 TTIs, e.g., TTI 402. Each TTI, e.g., the TTI 402, may have a duration of 2560 millisecond (ms), and may include 16 transmission periods each with a duration of 160 ms. The system information 415 may be repeatedly transmitted from an eNB to a UE 4 times within the TTI 402, shown in row (a); 8 times within the TTI 402, shown in row (b); or 16 times within the TTI 402, shown in row (c). As a consequence, the system information 415 may be received multiple times, e.g., 4, 8, or 16 times by a UE within a time window, e.g., the time window 401.

In more detail, a transmission period for the system information 415 may include 16 frames, e.g., frame 0, frame 1, . . . , frame 16. Each frame, e.g., frame 0, may include 10 subframes, and a portion of the system information 415 may be carried by one of the subframe, e.g., subframe 4 of the frame 0, for a transmission period of system information 415.

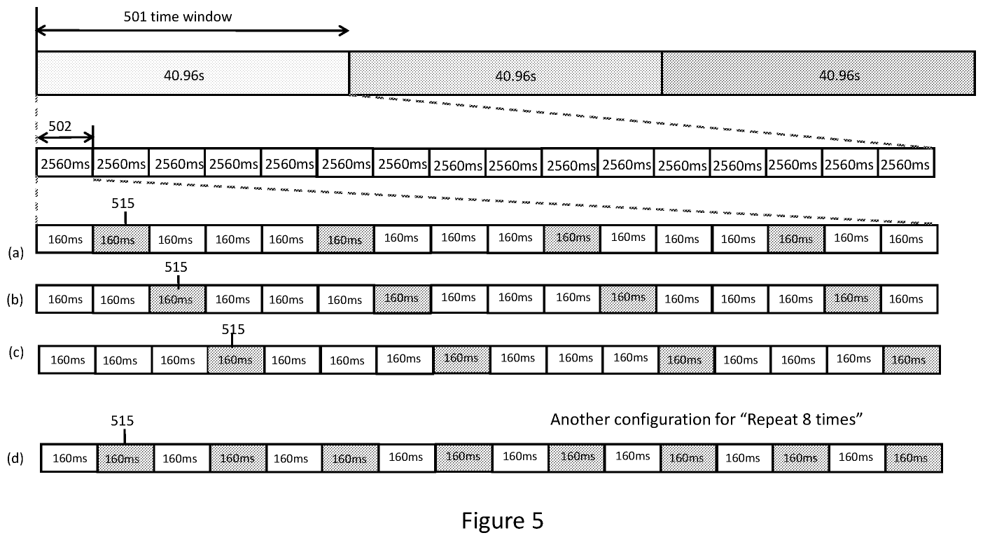

FIG. 5 illustrates another example time window 501 including a number of TTIs, and a number of copies of system information to be received within a TTI, in accordance with various embodiments. In embodiments, the time window 501 may be an example of the time window 201, the time window 301, the time window 302, or the time window 401.

In embodiments, the time window 501 may have a duration of 40.96 seconds, and may include 16 TTIs, e.g., TTI 502. Each TTI, e.g., the TTI 502, may have a duration of 2560 milliseconds (ms), and may include 16 transmission periods each with a duration of 160 ms. The system information 515 may be repeatedly transmitted from an eNB to a UE 4 times within the TTI 502. In some embodiments, the system information 515 may be transmitted in transmission periods 2, 6, 10, and 14, as shown in row (a), in transmission periods 3, 7, 11, and 15, as shown in row (b), or transmission periods 4, 8, 12, and 16, as shown in row (c). Furthermore, the system information 515 may be repeatedly transmitted from an eNB to a UE 8 times within the TTI 502, in transmission periods 2, 4, 6, 8, 10, 12, 14, and 16, as shown in row (d).

FIG. 4 and FIG. 5 merely illustrate example time windows including a number of TTIs, and a number of copies of system information to be received within a TTI, There may be other number of TTIs in a time window, and the system information may be transmitted or received within different transmission periods, frames, or subframes.

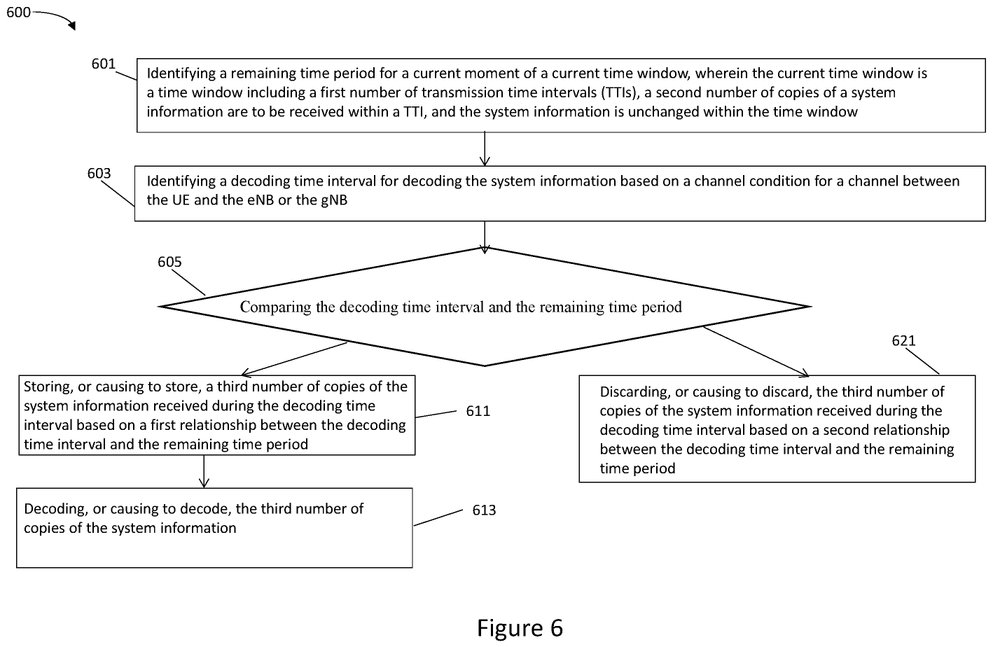

FIG. 6 illustrates an example operation flow 600 for a UE to determine to decode or discard one or more copies of system information within a decoding time interval, in accordance with various embodiments. In embodiments, the operation flow 600 may be performed by the UE 103, the UE 105, or the UE 107, as shown in FIG. 1.

The operation flow 600 may include, at 601, identifying a remaining time period for a current moment of a current time window, wherein the current time window is a time window including a first number of transmission time intervals (TTIs), a second number of copies of a system information are to be received within a TTI, and the system information is unchanged within the time window. In some embodiments, at 601, the UE 103, or the processing circuitry 143, may identify a remaining time period 305 within the time window 301 for the current moment 303. The time window 301 may have a duration of 40.96 seconds (s) and may include 16 TTIs as shown in FIG. 4 or FIG. 5.

The operation flow 600 may further include, at 603, identifying a decoding time interval for decoding the system information based on a channel condition for a channel between the UE and the eNB or the gNB. In some embodiments, at 603, the UE 103, or the processing circuitry 143, may identify the decoding time interval for decoding system information to be 4*2560 ms=10.24 s, which may be represented by the decoding time interval 307, when 64 copies of the system information 145 to be decoded. Similarly, the UE 103, or the processing circuitry 143, may identify the decoding time interval for decoding system information to be 2*2560 ms=5.12 s, which may be represented by the decoding time interval 309, when 32 copies of the system information 145 to be decoded.

The operation flow 600 may further include, at 605, comparing the decoding time interval and the remaining time period. For example, as a result of the comparison, the UE 103 or the processing circuitry 143 may determine that the decoding time interval 307 may be larger than the remaining time period 305, while the decoding time interval 309 may be smaller than the remaining time period 305.

The operation flow 600 may further include, at 611, storing, or causing to store, a third number of copies of the system information received during the decoding time interval based on a first relationship between the decoding time interval and the remaining time period. In some embodiments, at 611, the UE 103, or the processing circuitry 143, may store, or cause to store, in the memory 141, one or more copies of the system information 145 received during the decoding time interval 309, since the decoding time interval 309 may be smaller than the remaining time period 305.

The operation flow 600 may further include, at 613, decoding, or causing to decode, the third number of copies of the system information. In some embodiments, at 613, the UE 103, or the processing circuitry 143 may decode, or cause to decode, the one or more copies of the system information 145, received during the decoding time interval 309.

The operation flow 600 may further include, at 621, discarding, or causing to discard, the third number of copies of the system information received during the decoding time interval based on a second relationship between the decoding time interval and the remaining time period. In some embodiments, at 621, the UE 103, or the processing circuitry 143, may discard, or cause to discard, the one or more copies of the system information 115 received during the decoding time interval 307, or received during the remaining window 305.

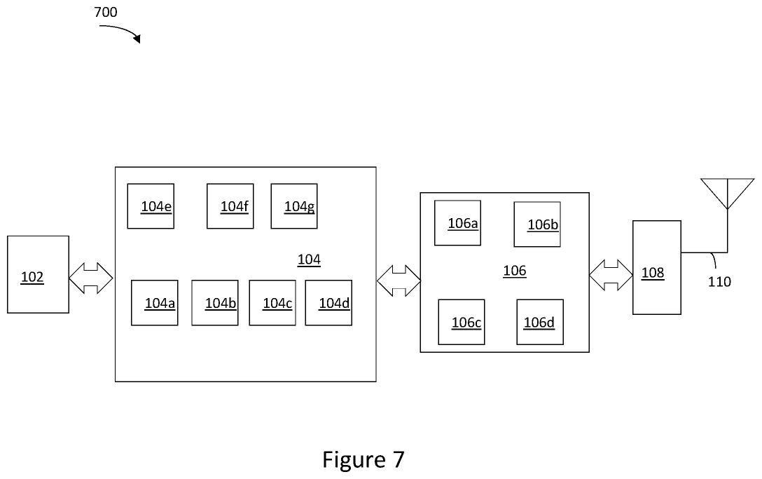

FIG. 7 illustrates a block diagram of an implementation 700 for eNBs, gNodeB, and/or UEs, in accordance with various embodiments. In one embodiment, using any suitably configured hardware and/or software, example components of an electronic device 700 may implement an eNB, or a UE of the wireless network 100 as shown in FIG. 1, e.g., the UE 103, the UE 105, the UE 107, or the eNB 101. In some embodiments, the electronic device 700 may include application circuitry 102, baseband circuitry 104, radio frequency (RF) circuitry 106, front-end module (FEM) circuitry 108, and one or more antennas 110, coupled together at least as shown. In embodiments where the electronic device 700 is implemented in or by an eNB, or a UE, the electronic device 700 may also include network interface circuitry (not shown) for communicating over a wired interface (for example, an X2 interface, an S1 interface, and the like). For example, the operation flow 600 shown in FIG. 6 may be performed by the application circuitry 102 or the baseband circuitry 104.

The application circuitry 102 may include one or more application processors. For example, the application circuitry 102 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 104 may include circuitry such as, but not limited to, one or more single-core or multi-core processors. The baseband circuitry 104 may include one or more baseband processors and/or control logic to process baseband signals received from a receive signal path of the RF circuitry 106 and to generate baseband signals for a transmit signal path of the RF circuitry 106. Baseband processing circuitry 104 may interface with the application circuitry 102 for generation and processing of the baseband signals and for controlling operations of the RF circuitry 106. For example, in some embodiments, the baseband circuitry 104 may include a second generation (2G) baseband processor 104a, third generation (3G) baseband processor 104b, fourth generation (4G) baseband processor 104c, and/or other baseband processor(s) 104d for other existing generations, generations in development or to be developed in the future (e.g., fifth generation (5G), 6G, etc.). The baseband circuitry 104 (e.g., one or more of baseband processors 104a-d) may handle various radio control functions that enable communication with one or more radio networks via the RF circuitry 106. The radio control functions may include, but are not limited to, signal modulation/demodulation, encoding/decoding, radio frequency shifting, etc. In some embodiments, modulation/demodulation circuitry of the baseband circuitry 104 may include Fast-Fourier Transform (FFT), precoding, and/or constellation mapping/demapping functionality. In some embodiments, encoding/decoding circuitry of the baseband circuitry 104 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 104 may include elements of a protocol stack such as, for example, elements of an D2D or evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 104e of the baseband circuitry 104 may be configured to run elements of the protocol stack for signaling of the PHY, MAC, RLC, PDCP and/or RRC layers. In some embodiments, the baseband circuitry may include one or more audio digital signal processor(s) (DSP) 104f. The audio DSP(s) 104f may be include elements for compression/decompression and echo cancellation and may include other suitable processing elements in other embodiments.

The baseband circuitry 104 may further include memory/storage 104g. The memory/storage 104g may be used to load and store data and/or instructions for operations performed by the processors of the baseband circuitry 104. Memory/storage for one embodiment may include any combination of suitable volatile memory and/or non-volatile memory. The memory/storage 104g may include any combination of various levels of memory/storage including, but not limited to, read-only memory (ROM) having embedded software instructions (e.g., firmware), random access memory (e.g., dynamic random access memory (DRAM)), cache, buffers, etc. The memory/storage 104g may be shared among the various processors or dedicated to particular processors.

Components of the baseband circuitry may be suitably combined in a single chip, a single chipset, or disposed on a same circuit board in some embodiments. In some embodiments, some or all of the constituent components of the baseband circuitry 104 and the application circuitry 102 may be implemented together such as, for example, on a system on a chip (SOC).

In some embodiments, the baseband circuitry 104 may provide for communication compatible with one or more radio technologies. For example, in some embodiments, the baseband circuitry 104 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 104 is configured to support radio communications of more than one wireless protocol may be referred to as multi-mode baseband circuitry.

RF circuitry 106 may enable communication with wireless networks using modulated electromagnetic radiation through a non-solid medium. In various embodiments, the RF circuitry 106 may include switches, filters, amplifiers, etc. to facilitate the communication with the wireless network. RF circuitry 106 may include a receive signal path which may include circuitry to down-convert RF signals received from the FEM circuitry 108 and provide baseband signals to the baseband circuitry 104. RF circuitry 106 may also include a transmit signal path which may include circuitry to up-convert baseband signals provided by the baseband circuitry 104 and provide RF output signals to the FEM circuitry 108 for transmission.

In some embodiments, the RF circuitry 106 may include a receive signal path and a transmit signal path. The receive signal path of the RF circuitry 106 may include mixer circuitry 106a, amplifier circuitry 106b and filter circuitry 106c. The transmit signal path of the RF circuitry 106 may include filter circuitry 106c and mixer circuitry 106a. RF circuitry 106 may also include synthesizer circuitry 106d for synthesizing a frequency for use by the mixer circuitry 106a of the receive signal path and the transmit signal path. In some embodiments, the mixer circuitry 106a of the receive signal path may be configured to down-convert RF signals received from the FEM circuitry 108 based on the synthesized frequency provided by synthesizer circuitry 106d. The amplifier circuitry 106b may be configured to amplify the down-converted signals and the filter circuitry 106c may be a low-pass filter (LPF) or band-pass filter (BPF) configured to remove unwanted signals from the down-converted signals to generate output baseband signals. Output baseband signals may be provided to the baseband circuitry 104 for further processing. In some embodiments, the output baseband signals may be zero-frequency baseband signals, although this is not a requirement. In some embodiments, mixer circuitry 106a of the receive signal path may comprise passive mixers, although the scope of the embodiments is not limited in this respect.

In some embodiments, the mixer circuitry 106a of the transmit signal path may be configured to up-convert input baseband signals based on the synthesized frequency provided by the synthesizer circuitry 106d to generate RF output signals for the FEM circuitry 108. The baseband signals may be provided by the baseband circuitry 104 and may be filtered by filter circuitry 106c. The filter circuitry 106c may include a low-pass filter (LPF), although the scope of the embodiments is not limited in this respect.

In some embodiments, the mixer circuitry 106a of the receive signal path and the mixer circuitry 106a of the transmit signal path may include two or more mixers and may be arranged for quadrature downconversion and/or upconversion respectively. In some embodiments, the mixer circuitry 106a of the receive signal path and the mixer circuitry 106a of the transmit signal path may include two or more mixers and may be arranged for image rejection (e.g., Hartley image rejection). In some embodiments, the mixer circuitry 106a of the receive signal path and the mixer circuitry 106a may be arranged for direct downconversion and/or direct upconversion, respectively. In some embodiments, the mixer circuitry 106a of the receive signal path and the mixer circuitry 106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 106 may include analog-to-digital converter (ADC) and digital-to-analog converter (DAC) circuitry and the baseband circuitry 104 may include a digital baseband interface to communicate with the RF circuitry 106.

In some embodiments, the synthesizer circuitry 106d may be a fractional-N synthesizer or a fractional N/N+1 synthesizer, although the scope of the embodiments is not limited in this respect as other types of frequency synthesizers may be suitable. For example, synthesizer circuitry 106d may be a delta-sigma synthesizer, a frequency multiplier, or a synthesizer comprising a phase-locked loop with a frequency divider.

The synthesizer circuitry 106d may be configured to synthesize an output frequency for use by the mixer circuitry 106a of the RF circuitry 106 based on a frequency input and a divider control input. In some embodiments, the synthesizer circuitry 106d may be a fractional N/N+1 synthesizer.

In some embodiments, frequency input may be provided by a voltage controlled oscillator (VCO), although that is not a requirement. Divider control input may be provided by either the baseband circuitry 104 or the applications processor 102 depending on the desired output frequency. In some embodiments, a divider control input (e.g., N) may be determined from a look-up table based on a channel indicated by the applications processor 102.

Synthesizer circuitry 106d of the RF circuitry 106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 106 may include an IQ/polar converter.

FEM circuitry 108 may include a receive signal path which may include circuitry configured to operate on RF signals received from one or more antennas 110, amplify the received signals and provide the amplified versions of the received signals to the RF circuitry 106 for further processing. FEM circuitry 108 may also include a transmit signal path which may include circuitry configured to amplify signals for transmission provided by the RF circuitry 106 for transmission by one or more of the one or more antennas 110.

In some embodiments, the FEM circuitry 108 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 106). The transmit signal path of the FEM circuitry 108 may include a power amplifier (PA) to amplify input RF signals (e.g., provided by RF circuitry 106), and one or more filters to generate RF signals for subsequent transmission (e.g., by one or more of the one or more antennas 110).

In some embodiments, the implementation 700 may include additional elements such as, for example, a display, a camera, one or more sensors, and/or interface circuitry (for example, input/output (I/O) interfaces or buses) (not shown). In embodiments where the electronic device is implemented in or by an eNB, the implementation 700 may include network interface circuitry. The network interface circuitry may be one or more computer hardware components that the connect the implementation 700 to one or more network elements, such as one or more servers within a core network or one or more other eNBs via a wired connection. To this end, the network interface circuitry may include one or more dedicated processors and/or field programmable gate arrays (FPGAs) to communicate using one or more network communications protocols such as X2 application protocol (AP), S1 AP, Stream Control Transmission Protocol (SCTP), Ethernet, Point-to-Point (PPP), Fiber Distributed Data Interface (FDDI), and/or any other suitable network communications protocols.

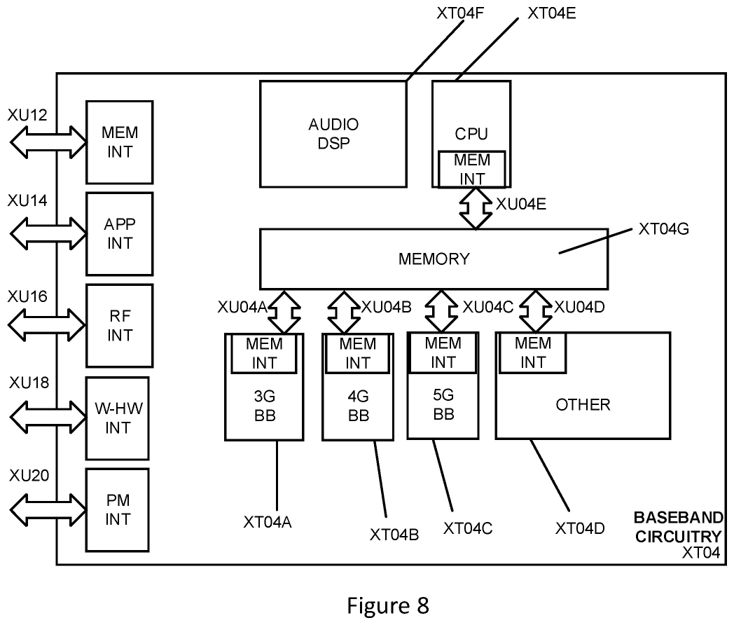

FIG. 8 illustrates interfaces of baseband circuitry XT04 as a part of an implementation for eNBs, gNodeB, and/or UEs, in accordance with various embodiments. The baseband circuitry XT04 may be similar to the baseband circuitry 104 of the implementation 700 for eNBs, gNodeB, and/or UEs, as shown in FIG. 7, which may comprise processors 104a-104e and a memory 104g utilized by said processors. In one embodiment, using any suitably configured hardware and/or software, example components of the baseband circuitry XT04 may implement an eNB, or a UE of the wireless network 100 as shown in FIG. 1, e.g., the UE 103, the UE 105, the UE 107, or the eNB 101. Each of the processors 104a-104e may include a memory interface, XU04A-XU04E, respectively, to send/receive data to/from the memory 104g. In some embodiments, the memory 104g may store information about a threshold condition, which may be associated with the first configuration, the second configuration, the first priority, or the second priority. The threshold condition may be used by processing circuitry, e.g., processors 104a-104e, to cause, based on the threshold condition, the data associated with the second service to be transmitted by the first physical resource of the first configuration associated with the first service.

The baseband circuitry 104 may further include one or more interfaces to communicatively couple to other circuitries/devices, such as a memory interface XU12 (e.g., an interface to send/receive data to/from memory external to the baseband circuitry XT04), an application circuitry interface XU14 (e.g., an interface to send/receive data to/from the application circuitry 102 of FIG. 7), an RF circuitry interface XU16 (e.g., an interface to send/receive data to/from RF circuitry 106 of FIG. 7), a wireless hardware connectivity interface XU18 (e.g., an interface to send/receive data to/from Near Field Communication (NFC) components, Bluetooth® components (e.g., Bluetooth® Low Energy), Wi-Fi® components, and other communication components), and a power management interface XU20 (e.g., an interface to send/receive power or control signals to/from the PMC XT12.

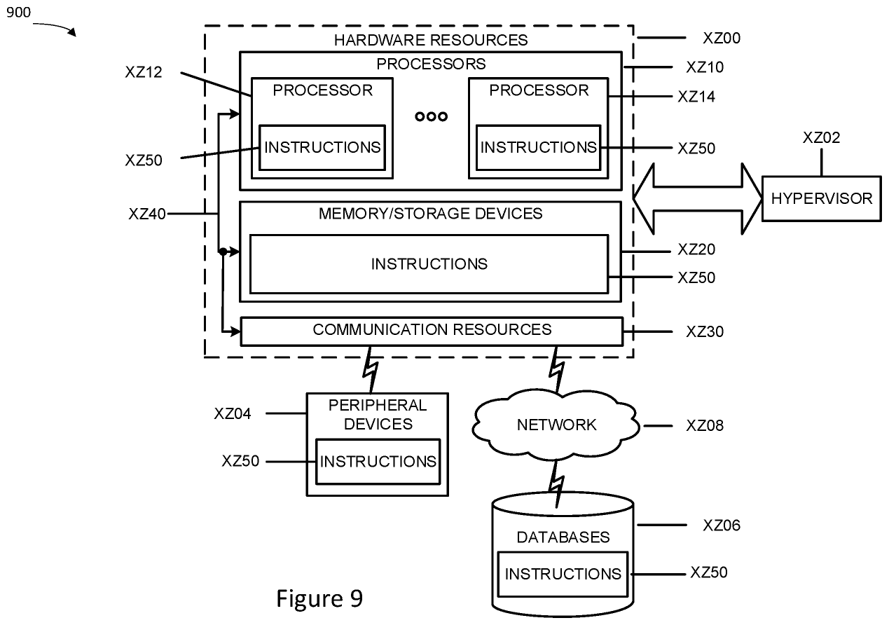

FIG. 9 illustrates a block diagram 900 illustrating components able to read instructions from a machine-readable or computer-readable medium (e.g., a non-transitory machine-readable storage medium) and perform any one or more of the methodologies discussed herein, in accordance with various embodiments.

Specifically, FIG. 9 shows a diagrammatic representation of hardware resources) (ZOO including one or more processors (or processor cores) XZ10, one or more memory/storage devices XZ20, and one or more communication resources XZ30, each of which may be communicatively coupled via a bus XZ40. For embodiments where node virtualization is utilized, a hypervisor XZ02 may be executed to provide an execution environment for one or more network slices/sub-slices to utilize the hardware resources) (ZOO The processors XZ10 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor XZ12 and a processor XZ14.

The memory/storage devices XZ20 may include main memory, disk storage, or any suitable combination thereof. The memory/storage devices XZ20 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources XZ30 may include interconnection or network interface components or other suitable devices to communicate with one or more peripheral devices XZ04 or one or more databases XZ06 via a network XZ08. For example, the communication resources XZ30 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions XZ50 may comprise software, a program, an application, an applet, an app, or other executable code for causing at least any of the processors XZ10 to perform any one or more of the methodologies discussed herein. For example, instructions XZ50 may be configured to enable a device, e.g., the UE 103, the UE 105, the UE 107 as shown in FIG. 1, in response to execution of the instructions XZ50, to implement (aspects of) any of the operation flows or elements described throughout this disclosure related to a UE, e.g., FIG. 6, to identify a remaining time period for a current moment of a current time window; identify a decoding time interval for decoding system information based on a channel condition for a channel between the UE and the eNB or the gNB; store, or cause to store, in a memory one or more copies of the system information received during the decoding time interval based on a first relationship between the decoding time interval and the remaining time period; and decode, or cause to decode, the one or more copies of the system information, in accordance with various embodiments. In some embodiments, the instructions XZ50 may reside, completely or partially, within at least one of the processors XZ10 (e.g., within the processor's cache memory), the memory/storage devices XZ20, or any suitable combination thereof. Furthermore, any portion of the instructions XZ50 may be transferred to the hardware resources)(ZOO from any combination of the peripheral devices XZ04 or the databases XZ06. Accordingly, the memory of processors XZ10, the memory/storage devices XZ20, the peripheral devices XZ04, and the databases XZ06 are examples of computer-readable and machine-readable media.

The present disclosure is described with reference to flowchart illustrations or block diagrams of processes, apparatus (systems) and computer program products according to embodiments of the disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means that implement the function/act specified in the flowchart or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart or block diagram block or blocks.

### EXAMPLES

Example 1 may include an apparatus to be used in a user equipment (UE) in a mobile communication network to communicate with an evolved Node B (eNB) or a next generation Node B (gNB), comprising: a memory; and processing circuitry, coupled with the memory, the processing circuitry to: identify a remaining time period of a current moment in a current time window; identify a decoding time interval for decoding system information based on a channel condition for a channel between the UE and the eNB or the gNB; store, or cause to store, in the memory one or more copies of the system information received during the decoding time interval based on a first relationship between the decoding time interval and the remaining time period; and decode, or cause to decode, the one or more copies of the system information.

Example 2 may include the apparatus of example 1, wherein the processing circuitry is further to decode at least one copy of the system information stored within the current time window before the current moment.

Example 3 may include the apparatus of example 1, wherein the processing circuitry is further to: discard, or cause to discard, the one or more copies of the system information received during the decoding time interval based on a second relationship between the decoding time interval and the remaining time period.

Example 4 may include the apparatus of any one of examples 1-3, wherein the processing circuitry is to store, or cause to store, the one or more of copies of the system information received during the decoding time interval based on the first relationship to indicate that the decoding time interval has a duration shorter than or equal to a duration of the remaining time period.

Example 5 may include the apparatus of any one of examples 1-3, wherein the current time window is a time window including a first number of transmission time intervals (TTIs), the system information is unchanged within the time window, a second number of copies of the system information are to be received within a TTI, and the second number of copies of the system information is 4, 8, or 16.

Example 6 may include the apparatus of any one of examples 1-3, wherein the system information is carried by multiple frames within a transmission time interval (TTI), and the current time window is a time window including one or more TTIs.

Example 7 may include the apparatus of any one of examples 1-3, wherein a first portion of the system information is carried by a first subframe of a first frame, and a second portion of the system information is carried by a second subframe of a second frame.

Example 8 may include the apparatus of any one of examples 1-3, wherein the system information includes information for system configuration, resource allocation, or scheduling and is carried by a master information block (MIB), a system information block (SIB) 1, a SIB 2, or a SIB 3.

Example 9 may include the apparatus of any one of examples 1-3, wherein the current time window is a time window including one or more transmission time intervals (TTIs), the current time window has a duration of 40.96 second, and a TTI has a duration of 2560 millisecond (ms).

Example 10 may include the apparatus of any one of examples 1-3, wherein the channel condition is indicated by a signal-to-noise ratio (SNR) of the channel between the UE and the eNB or the gNB.

Example 11 may include the apparatus of any one of examples 1-3, wherein the current time window is a time window including one or more transmission time intervals (TTIs), and the decoding time interval includes multiple TTIs.

Example 12 may include the apparatus of any one of examples 1-3, wherein the UE is an internet of things (IoT) UE, a machine type communication (MTC) UE, machine-to-machine (M2M) UE, a narrowband IoT (NB-IoT) UE, or a mobile IoT (MIoT) UE.

Example 13 may include the apparatus of any one of examples 1-3, wherein the mobile communication network is a narrowband-internet of things (NB-IoT) network, and the channel is a narrowband channel with a bandwidth of 180 kHz or 200 kHz.

Example 14 may include a computer-readable medium comprising instructions to cause a user equipment (UE) in a mobile communication network to communicate with an evolved Node B (eNB) or a next generation Node B (gNB), upon execution of the instructions by one or more processors, to: identify a remaining time period for a current moment of a current time window; identify a decoding time interval for decoding system information based on a channel condition for a channel between the UE and the eNB or the gNB; store, or cause to store, in a memory one or more copies of the system information received during the decoding time interval based on a first relationship between the decoding time interval and the remaining time period; and decode, or cause to decode, the one or more copies of the system information.

Example 15 may include the computer-readable medium of example 14, wherein the instructions upon execution by one or more processors, is further to cause the UE to: discard, or cause to discard, the one or more copies of the system information received during the decoding time interval based on a second relationship between the decoding time interval and the remaining time period.

Example 16 may include the computer-readable medium of any one of examples 14-15, wherein the current time window is a time window including a first number of transmission time intervals (TTIs), the system information is unchanged within the time window, a second number of copies of the system information are to be received within a TTI, and the second number of copies of the system information is 4, 8, or 16.

Example 17 may include the computer-readable medium of any one of examples 14-15, wherein the system information is carried by multiple frames within a transmission time interval (TTI), and the current time window is a time window including one or more TTIs.

Example 18 may include the computer-readable medium of any one of examples 14-15, wherein a first portion of the system information is carried by a first subframe of a first frame, and a second portion of the system information is carried by a second subframe of a second frame.

Example 19 may include the computer-readable medium of any one of examples 14-15, wherein the system information includes information for system configuration, resources allocation, or scheduling, carried by a master information block (MIB), a system information block 1, 2, or 3 (SIB1, SIB2, SIB3).

Example 20 may include the computer-readable medium of any one of examples 14-15, wherein the current time window is a time window including one or more transmission time intervals (TTIs), the current time window has a duration of 40.96 second, and a TTI has a duration of 2560 millisecond (ms).

Example 21 may include the computer-readable medium of any one of examples 14-15, wherein the UE is an internet of things (IoT) UE, a machine type communication (MTC) UE, machine-to-machine (M2M) UE, a narrowband IoT (NB-IoT) UE, or a mobile IoT (MIoT) UE.

Example 22 may include a method for a user equipment (UE) in a mobile communication network to communicate with an evolved Node B (eNB) or a next generation Node B (gNB), comprising: identifying a remaining time period for a current moment of a current time window, wherein the current time window is a time window including a first number of transmission time intervals (TTIs), a second number of copies of a system information are to be received within a TTI, and the system information is unchanged within the time window; identifying a decoding time interval for decoding the system information based on a channel condition for a channel between the UE and the eNB or the gNB; storing, or causing to store, a third number of copies of the system information received during the decoding time interval based on a first relationship between the decoding time interval and the remaining time period; and decoding, or causing to decode, the third number of copies of the system information.

Example 23 may include the method of example 22, further comprising: discarding, or causing to discard, the third number of copies of the system information received during the decoding time interval based on a second relationship between the decoding time interval and the remaining time period.

Example 24 may include the method of any one of examples 22-23, wherein the system information includes information for system configuration, resources allocation, or scheduling, carried by a master information block (MIB), a system information block 1, 2, or 3 (SIB1, SIB2, SIB3).

Example 25 may include the method of any one of examples 22-23, wherein the time window has a duration of 40.96 second, and a TTI has a duration of 2560 millisecond (ms).

Example 26 may include an apparatus to be used in a user equipment (UE) in a mobile communication network to communicate with an evolved Node B (eNB) or a next generation Node B (gNB), comprising: means for identifying a remaining time period for a current moment of a current time window, wherein the current time window is a time window including a first number of transmission time intervals (TTIs), a second number of copies of a system information are to be received within a TTI, and the system information is unchanged within the time window; means for identifying a decoding time interval for decoding the system information based on a channel condition for a channel between the UE and the eNB or the gNB; means for storing, or causing to store, a third number of copies of the system information received during the decoding time interval based on a first relationship between the decoding time interval and the remaining time period; and means for decoding, or causing to decode, the third number of copies of the system information.

Example 27 may include the apparatus of example 26, further comprising: means for discarding, or causing to discard, the third number of copies of the system information received during the decoding time interval based on a second relationship between the decoding time interval and the remaining time period.

Example 28 may include the apparatus of any one of examples 26-27, wherein the system information includes information for system configuration, resources allocation, or scheduling, carried by a master information block (MIB), a system information block 1, 2, or 3 (SIB1, SIB2, SIB3).

Example 29 may include the apparatus of any one of examples 26-27, wherein the time window has a duration of 40.96 second, and a TTI has a duration of 2560 millisecond (ms).

Example 30 may include for repetition-based transmission, such as system information block transmission, depending on factors, such as time limit and SNR levels, a UE can decide if to start or continue to accumulate repetitive transmission copies and try to decode the current information in transmission.

Example 31 may include for repetition-based transmission, such system information block transmission, depending on factors, such as time limit and SNR levels, a UE can decide if to stop accumulating repetitive transmission copies, and wait to re-start accumulation and try to decode information after a period of time.

Example 32 may include an apparatus comprising means to perform one or more elements of a method described in or related to any of examples 1-31, or any other method or process described herein.

Example 33 may include one or more non-transitory computer-readable media comprising instructions to cause an electronic device, upon execution of the instructions by one or more processors of the electronic device, to perform one or more elements of a method described in or related to any of examples 1-31, or any other method or process described herein.

Example 34 may include an apparatus comprising logic, modules, and/or circuitry to perform one or more elements of a method described in or related to any of examples 1-31, or any other method or process described herein.

Example 35 may include a method, technique, or process as described in or related to any of examples 1-31, or portions or parts thereof.

Example 36 may include an apparatus comprising: one or more processors and one or more computer readable media comprising instructions that, when executed by the one or more processors, cause the one or more processors to perform the method, techniques, or process as described in or related to any of examples 1-31, or portions thereof.

Example 37 may include a method of communicating in a wireless network as shown and described herein.

Example 38 may include a system for providing wireless communication as shown and described herein.

Example 39 may include a device for providing wireless communication as shown and described herein.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. An apparatus to be used in a user equipment (UE) in a mobile communication network to communicate with an evolved Node B (eNB) or a next generation Node B (gNB), the apparatus comprising:
a memory; and
processing circuitry, coupled with the memory, the processing circuitry to:
identify a remaining time period of a current moment in a current time window;
identify a decoding time interval for decoding system information based on a channel condition for a channel between the UE and the eNB or the gNB;
store, or cause to store, in the memory one or more copies of the system information received during the decoding time interval based on a first relationship between the decoding time interval and the remaining time period; and
decode, or cause to decode, the one or more copies of the system information.

2. The apparatus of claim 1, wherein the processing circuitry is further to decode at least one copy of the system information stored within the current time window before the current moment.

3. The apparatus of claim 1, wherein the processing circuitry is further to:
discard, or cause to discard, the one or more copies of the system information received during the decoding time interval based on a second relationship between the decoding time interval and the remaining time period.

4. The apparatus of claim 1, wherein the processing circuitry is to store, or cause to store, the one or more of copies of the system information received during the decoding time interval based on the first relationship to indicate that the decoding time interval has a duration shorter than or equal to a duration of the remaining time period.

5. The apparatus of claim 1, wherein the current time window is a time window including a first number of transmission time intervals (TTIs), the system information is unchanged within the time window, a second number of copies of the system information are to be received within a TTI, and the second number of copies of the system information is 4, 8, or 16.

6. The apparatus of claim 1, wherein the system information is carried by multiple frames within a transmission time interval (TTI), and the current time window is a time window including one or more TTIs.

7. The apparatus of claim 1, wherein a first portion of the system information is carried by a first subframe of a first frame, and a second portion of the system information is carried by a second subframe of a second frame.

8. The apparatus of claim 1, wherein the system information includes information for system configuration, resource allocation, or scheduling, and is carried by a master information block (MIB), a system information block (SIB) 1, a SIB 2, or a SIB 3.

9. The apparatus of claim 1, wherein the current time window is a time window including one or more transmission time intervals (TTIs), the current time window has a duration of 40.96 second, and a TTI has a duration of 2560 millisecond (ms).

10. The apparatus of claim 1, wherein the channel condition is indicated by a signal-to-noise ratio (SNR) of the channel between the UE and the eNB or the gNB.

11. The apparatus of claim 1, wherein the current time window is a time window including one or more transmission time intervals (TTIs), and the decoding time interval includes multiple TTIs.

12. The apparatus of claim 1, wherein the UE is an internet of things (IoT) UE, a machine type communication (MTC) UE, machine-to-machine (M2M) UE, a narrowband IoT (NB-IoT) UE, or a mobile IoT (MIoT) UE.

13. The apparatus of claim 1, wherein the mobile communication network is a narrowband-internet of things (NB-IoT) network, and the channel is a narrowband channel with a bandwidth of 180 kHz or 200 kHz.

14. A computer-readable medium comprising instructions to cause a user equipment (UE) in a mobile communication network to communicate with an evolved Node B (eNB) or a next generation Node B (gNB), upon execution of the instructions by one or more processors, to:
identify a remaining time period for a current moment of a current time window;
identify a decoding time interval for decoding system information based on a channel condition for a channel between the UE and the eNB or the gNB;
store, or cause to store, in a memory one or more copies of the system information received during the decoding time interval based on a first relationship between the decoding time interval and the remaining time period; and
decode, or cause to decode, the one or more copies of the system information.

15. The computer-readable medium of claim 14, wherein the instructions upon execution by one or more processors, is further to cause the UE to:
discard, or cause to discard, the one or more copies of the system information received during the decoding time interval based on a second relationship between the decoding time interval and the remaining time period.

16. The computer-readable medium of claim 14, wherein the current time window is a time window including a first number of transmission time intervals (TTIs), the system information is unchanged within the time window, a second number of copies of the system information are to be received within a TTI, and the second number of copies of the system information is 4, 8, or 16.

17. The computer-readable medium of claim 14, wherein the system information is carried by multiple frames within a transmission time interval (TTI), and the current time window is a time window including one or more TTIs.

18. The computer-readable medium of claim 14, wherein a first portion of the system information is carried by a first subframe of a first frame, and a second portion of the system information is carried by a second subframe of a second frame.

19. The computer-readable medium of claim 14, wherein the system information includes information for system configuration, resources allocation, or scheduling, carried by a master information block (MIB), a system information block 1, 2, or 3 (SIB1, SIB2, SIB3).

20. The computer-readable medium of claim 14, wherein the current time window is a time window including one or more transmission time intervals (TTIs), the current time window has a duration of 40.96 second, and a TTI has a duration of 2560 millisecond (ms).

21. The computer-readable medium of claim 14, wherein the UE is an internet of things (IoT) UE, a machine type communication (MTC) UE, machine-to-machine (M2M) UE, a narrowband IoT (NB-IoT) UE, or a mobile IoT (MIoT) UE.

22. An apparatus to be used in a user equipment (UE) in a mobile communication network to communicate with an evolved Node B (eNB) or a next generation Node B (gNB), comprising:
means for identifying a remaining time period for a current moment of a current time window, wherein the current time window is a time window including a first number of transmission time intervals (TTIs), a second number of copies of a system information are to be received within a TTI, and the system information is unchanged within the time window;
means for identifying a decoding time interval for decoding the system information based on a channel condition for a channel between the UE and the eNB or the gNB;
means for storing, or causing to store, a third number of copies of the system information received during the decoding time interval based on a first relationship between the decoding time interval and the remaining time period; and
means for decoding, or causing to decode, the third number of copies of the system information.

23. The apparatus of claim 22, further comprising:
means for discarding, or causing to discard, the third number of copies of the system information received during the decoding time interval based on a second relationship between the decoding time interval and the remaining time period.

24. The apparatus of claim 22, wherein the system information includes information for system configuration, resources allocation, or scheduling, carried by a master information block (MIB), a system information block 1, 2, or 3 (SIB1, SIB2, SIB3).

25. The apparatus of claim 22, wherein the time window has a duration of 40.96 second, and a TTI has a duration of 2560 millisecond (ms).
